(19) United States
(12) Patent Application Publication
(10) Pub. No.: US 2011/0090841 A1
(43) Pub. Date: Apr. 21, 2011

(54) Relay Multiple Access Wireless Networks

(75) Inventors: Dong-Jye Shyy, Vienna, VA (US); Mohamed Tamer Abdelrahman Refaei, Bethesda, MD (US)

(73) Assignee: MITRE Corporation, McLean, VA (US)

(21) Appl. No.: 12/580,624

(22) Filed: Oct. 16, 2009

(51) Int. Cl. H04W 40/22

(52) U.S. Cl. 370/319

(57) ABSTRACT

A system and method direct to an intelligent, adaptive, multiple-access relays that can form their own network, optimize their own attributes, utilize their own resources, influence the configurable components of the wireless network around it, and transform the characteristics of the wireless network towards its mission requirements and goals.

### FIELD OF THE INVENTION

This invention relates to the field of communication relays with cognitive abilities for wireless networks, and methods for utilizing relays with cognitive ability in wireless networks.

### BACKGROUND OF THE INVENTION

Traditionally, when the range of single-hop wireless communication is limited by distance or harsh radio propagation conditions, radio-frequency (RF) repeaters or baseband relays can be used to extend the communication range through multi-hop relaying. In addition, the capacity of a wireless network can be enhanced by deploying baseband relays (not RF repeaters) to enable higher order of modulation and coding schemes. It is generally understood that baseband relays have wider applications, and therefore are applicable in more situations. For example, baseband relays can be utilized in indoor/outdoor public safety emergency incidents, military urban search and clear/rescue operation and tactical deployment. Their applications can also be realized in remote locations where extended network coverage or increased capacity is needed to interconnect on-ground personnel and command-and-control units (e.g. wild land fires and military mountain/desert operations).

Relays are typically self-contained, manually-installed, portable devices. They are manually introduced into the network and are assigned a particular mission towards which their internal configurable parameters are decided beforehand. For instance, relays that are introduced into a wireless network to extend their communication range are positioned in the network at a pre-calculated location, transmit power and height, and are configured to relay traffic between isolated portions of the network. Their configuration and functionalities mostly remain unchanged post-deployment. The static deployment of relays is often not able to meet the dynamic mission requirements of users, e.g., government applications.

What is needed is a relay that is able to form a rapidly deployable wireless network (cellular or ad-hoc) by itself, supplement the existing wireless network (cellular or ad-hoc) by influencing the network's configurable components and transforming the network's characteristics without changing the waveform and the stacks of the existing network, or both.

### SUMMARY OF THE INVENTION

The foregoing and other objects, aspects, features, and advantages of the invention will become more apparent from the following description and from the claims.

In one aspect of the present invention, the invention features a relay for a wireless communication network. In some embodiments the relay includes a mission-awareness component configured to identify mission requirements based on information received from a mission station, a context-awareness component configured to gather information about an existing wireless communications network in communication with the relay or monitored by the relay, a knowledge-based component configured to organize and retrieve data collected from the existing wireless communication network and stored by the relay. In some embodiments, the relay also includes a decision process component configured to optimize the relay attributes and select the relay resources such that the relay achieves the mission requirements by doing at least one of (a) creating a new wireless communication network or (b) configuring the existing wireless communications network without altering waveform characteristics and network protocol stacks of the existing wireless communications network, and an execution component configured to optimize the relay attributes and select the relay resources in conformance with the selection made by the decision process component.

In a further aspect of the invention, the invention features a wireless communication network. The wireless communication network comprises one or more network devices with resources, and a relay that is adapted to interface with the one or more network devices and adapted to alter the resources of the one or more network devices without altering waveform characteristics and network protocol stacks of the wireless communication network. In some embodiments the relay includes a mission-awareness component configured to identify mission requirements based on information received from a mission station, a context-awareness component configured to gather information about an existing wireless communications network in communication with the relay, a knowledge-based component configured to organize and retrieve data collected from the existing wireless communication network and stored by the relay, a decision process component configured to select relay attributes and relay resources such that the relay achieves the mission requirements by doing at least one of (a) creating a new wireless network, or (b) configuring the existing wireless network without altering a carrier waveform characteristics and network protocol stack of the existing wireless communications network, and an execution component configured to adapt the relay attributes and relay resources in conformance with the selections made by the decision process component.

In another aspect of the invention, the invention features a method of utilizing a relay. In some embodiments, the method identifies mission requirements based on data received from a mission station. The method also includes gathering information about an existing wireless communications network in communication with the relay, organizing data collected from the existing wireless communication network and stored by the relay, determining whether to form a new wireless network, configure the existing wireless communication network, or form a new wireless network and configure the existing wireless communication network to achieve the mission requirements, selecting relay attributes and relay resources based on the determining step, and adapting the relay attributes and relay resources based on the selecting step such that the relay achieves the mission requirements by doing at least one of (a) creating the new wireless network, or (b) configuring the existing wireless network by altering one or more resources of one or more network devices in the existing wireless communication network without altering a waveform characteristic and a network protocol stack of the existing wireless communication network.

Any of the aspects above can include one or more of the following features. In some embodiments the relay attributes comprise location and mobility pattern. The relay resources can include time division, frequency or channel division, code division, hop division, delay division, space division, route division, transmit power division, power consumption division, and modulation and coding division. The relay can also utilize a network management component to recognize the relay resources of the one or more network devices in the existing wireless communication network.

The aspects can also include one or more of the following features. The relay can be configured to communicate with one or more relays, the relay can also be configured to operate as a subscriber unit, and the relay resources can be configured in any combination to meet the mission requirements. In some embodiments, the relays can ensure interoperability of the existing wireless communication network and one or more additional wireless communication networks. The relay can also serve as a network manager when configuring the existing wireless communication network.

The aspects above can also include one or more of the following features. The mission requirements can be dynamic. The mission requirements can also include choosing a different spectrum band, ensuring coexistence with other surrounding wireless networks that may cause interference, supporting mesh topology, supporting multicast, providing desired quality of service for user data, providing confidentiality, integrity, and reliability of data, providing low probability of jamming, interception and detection, supporting firewall for blocking malicious users, supporting secured storage under threat, supporting location service, supporting user mobility or some combination thereof.

Any of the aspects above can also include one or more of the following features. The context-awareness component can gather information by recognizing the waveforms and protocol stacks of the existing wireless network, monitoring broadcast messages of the existing wireless communication network, exchanging messages with the existing wireless communication network, exchanging messages with one or more additional relays, or any combination thereof. In some embodiments, the context-awareness component can gather information that includes spectrum bands, loading conditions of the existing wireless communication network, the configuration of the existing wireless communication network, and the attributes of other relays. The context-awareness component can also be configured to scan the broadcast spectrum, identify the available bands, and identify the characteristics of each band. In some embodiments, the data process component can receive data from the mission-awareness component, the context awareness component, the knowledge-based component, or some combination thereof.

### BRIEF DESCRIPTION OF THE DRAWINGS

FIG. 1 shows a schematic of a relay that embodies the present invention incorporated into an existing communication network.

FIG. 2 shows an embodiment of the interaction between the various components of a relay.

FIG. 3 shows the steps utilized by a relay embodying the present invention.

### DETAILED DESCRIPTION OF THE INVENTION

Communication networks can be incorporated or used by groups or organizations that have specific network mission requirements that must be achieved by the network for the group to succeed at their larger mission goals. These network mission requirements can include quality of service (QoS), connectivity, throughput, security, mobility, anti-jamming, and low probability of interception/low probability of detection (LPI/LPD). The present invention includes relays that are aware of the mission requirements and are able to configure the attributes of the relay itself, other nodes in an existing network, or other relays to accomplish the mission requirements and overall mission goals. The relay can also adapt to changing or evolving mission requirements. In some embodiments the relay can also be self-configuring and can also serve as network managers which use secure Simple Network Management Protocol (SNMP). SNMP is used in network management systems to monitor network-attached devices for conditions that warrant administrative attention. The disclosed relays can use SNMP to configure the attributes of both other relays and also attributes of existing wireless nodes or components.

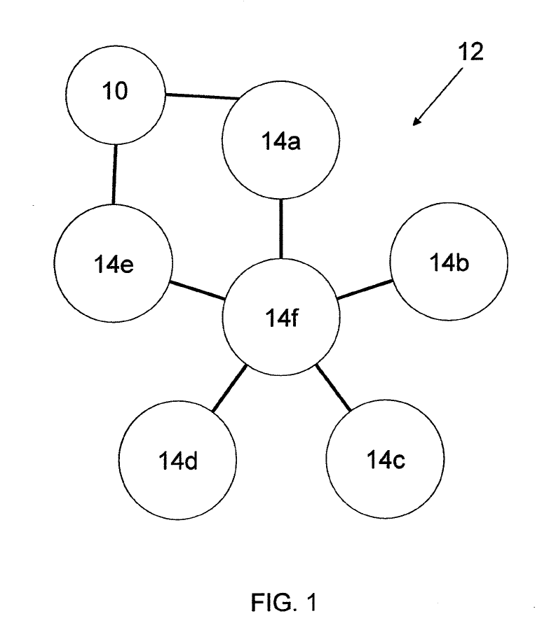

In some embodiments, FIG. 1, the relay 10 can supplement an existing wireless network 12, FIG. 1, by influencing and/or transforming the characteristics of the nodes 14a-14e that make up the existing network. In some embodiments, the nodes 14a-14e could include wireless technologies such as GSM, CDMA2000, W-CDMA, 802.11, 802.16 (or WiMAX), and Long Term Evolution (LTE). The relay can also form a new wireless network with other relays in some embodiments, and the relay can also incorporate one or more other relays into an existing wireless network if additional relays are necessary to accomplish the mission requirements. In some embodiments the relay can transform the existing network's characteristics without changing the waveform and/or the stacks of the existing network. The relay can accomplish this by recognizing the waveforms of the existing networks and sensing the existing network. The relay 10 can also optimize the attributes of the existing nodes to accomplish the mission requirements. With an existing network 12, the relay can accomplish the mission requirements by selecting it's own available resources while also influencing the configurable components of the nodes in the existing network 12. In some embodiments, the attributes can be related to the transport layer, the network layer, the MAC layer, and the physical layer of the relay. Other attributes can be seen below, Table 1. The configurable components of the existing network nodes can include Antenna layer: Antenna type, beamwidth and gain; Physical layer: waveform, frequency, transmit power, modulation/coding scheme, and channel size; MAC layer: multiple access method, retransmission protocol and fragmentation threshold; Security layer: security policy, authentication and encryption techniques; Network layer: IP address, network mask, routing protocol, and compression information; Transport layer: TCP flavor, maximal segment size, acknowledgement scheme and congestion window size.

TABLE 1
Basic Attributes

| | |
|---|---|
| Location | Relay location may be changed to better serve the mission goals. |
| Mobility | Relay mobility pattern may also change for the same purpose. |
| Pattern | |

Basic Resources

| | |
|---|---|
| Time Division | Separation of time to allow multiple nodes to transmit without |
| | contention; e.g. Time Division Multiple Access (TDMA). |
| Frequency | Separation in frequency to allow multiple access. Frequency |
| (channel) | division multiple access (FDMA), Orthogonal frequency division |
| Division | multiple access (OFDMA) or orthogonal frequency division |
| | multiplexing (OFDM) are a form of frequency division. |
| Code Division | Use of different codes to allow nodes to transmit at the same time; |
| | e.g., CDMA. |
| Hop Division | Proper scheduling of the transmission of messages at different hops |
| | can also introduce orthogonal transmission from different nodes |
| Delay Division | Proper scheduling of retransmission of the same message can also |
| | allow multiple nodes to transmit without contention. ARQ and |
| | Hybrid-ARQ are a form of delay division. |
| Space Division | The antenna pattern (and antenna height) is used to separate the |
| | node transmission. Multiple input and multiple output (MIMO) is a |
| | form of space division. |
| Route Division | More than one relay can create multiple routes from a parent node |
| | and child nodes which can allow multiple child nodes to transmit |
| | without contention. |
| Transmit | Transmit power is optimized to reduce interference from multiple |
| Power Division | nodes' transmission. |
| Power | Instruct nodes to go into sleep or idle mode to create transmission |
| Consumption | opportunity for other nodes or to conserve battery power. |
| Division | |
| Modulation | Lower order modulation and coding schemes have a larger |
| and coding | interference margin than higher modulation and coding schemes. |
| Division | By using a lower modulation and coding scheme, the link can have a |
| | better chance of coexisting with other links. Higher order |
| | modulation and coding scheme can also increase the capacity of the |
| | network. |

In some embodiments, the mission requirements can include security. The reliability of a wireless network can be enhanced by increasing the SINR of the links. The routing diversity can also be provided by varying the density of relays. The mission requirements can also include a group specific frequency band, e.g., a military frequency band. To accomplish the mission requirement a new frequency band can be introduced by asking the relay to perform band translation. In some embodiments, the mission requirement of higher throughput can be accomplished by properly placing the relays between the base station and the subscribers. The subscribers can be customer premise equipment (CPE), handset, PC card or USB dongle. The relay can use a higher order of modulation and coding scheme for the subscriber and thereby increase the capacity of the cell. The mission requirements can also include improving the range of the communication network. Relays can be used to extend the range of a cell by providing multi-hop capability. Another mission requirement can be spectrum coexistence. If a few cells are congested they can radiate full power on the downlink. By properly positioning the relays at desired locations, the overall interference characteristics can be changed. For example, a link uses QuadraturePhase Shift Keying (QPSK), a passband signal generated through modulating complex data symbols with four different angles of a carrier frequency, for transmitting information to a subscriber. By adding a relay, the modulation scheme can be upgraded to a higher order scheme such as 16 QAM or 64 QAM. The same link can support more capacity. The net effect is either more users can be supported or the transmit power can be reduced. Another example is to use relays to instruct the subscribers to go into sleep or idle mode such that the subscribers' interference is reduced. In some embodiments, the mission requirements include base station mobility. In these embodiments, a fixed wireless network (such a military camp) has the needs to extend their coverage range dynamically into other areas. By properly positioning the relays at desired locations, allowing the relays to connect to one another, and allowing the relay to move (while still maintaining the connectivity among each other and the infrastructure in the existing wireless network), the relay transforms a fixed wireless network to a mobile wireless network. The mission requirements can also include requiring a mesh wireless network. In some embodiments, a wireless network supports only a point to multipoint topology. By properly positioning the relays at desired location, allowing the relays to communicate with each other, and supporting routing protocol, the relays can transform a static wireless network to a mesh wireless network. In some embodiments, the mission requirement can also support multicast networking. By properly placing relays between a cell and subscribers, a multicast tree can be formed among relays to support multicast traffic. In some embodiments, the mission requirements will be security related, for example can require support of an access list and/or secured storage under threat. The relay can then act as a firewall to allow connection requests from the subscribers or block those from malicious users, and in some embodiments, the relay can store the user information temporarily when the relay detects threat.

The relay can also recognize mission requirements that include optimized location services. In some embodiments, the relay networks can choose the appropriate multiple access technique(s) to support the location service for disparate environments. The decision of which multiple access technique to be used is based on the resource available. For example, the resources provided by a multiple access technique (space [antenna], frequency [channel], code, time [ARQ and H-ARQ], hop, and diversity [time, spatial and frequency], and synchronization granularity) can be considered when choosing the correct resource for location service to meet the mission requirements.

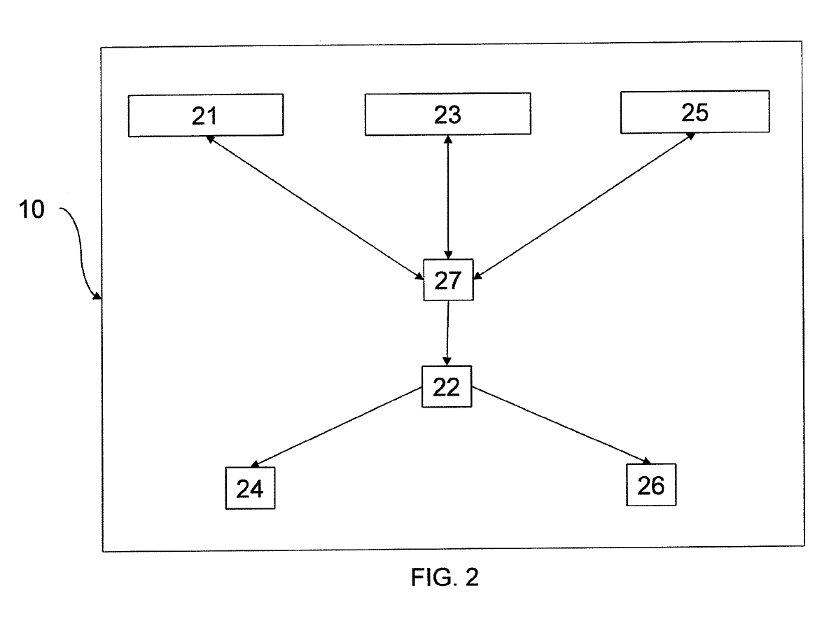

The architecture of the relay, FIG. 2, can be distinguished by the two different phases that the components are used for: the analysis phase and the execution phase. The analysis and execution phase components can be incorporated into a single device, e.g., a cognitive radio programmed to accomplish the mission requirements, or in some embodiments, the components can be embodied in separate components, and in some embodiments, the components can be combined in several different modules, each module incorporating one or more of the components described below.

The analysis phase components can include mission-awareness components 21, context-awareness component 23, knowledge-based components 25, and decision-process components 27.

The mission awareness component 21 is aware of the mission requirements, which can be dynamic. In some embodiments, successful and timely delivery of data are the primary mission requirements, while in some embodiments, latency can be sacrificed as a mission requirement in favor of other mission requirements, including guaranteed confidentiality and security and integrity of the transmitted data. The mission requirements can also include any of the requirements discussed above, or any requirements necessary for the relay operator to accomplish the overall mission goal. The mission awareness component 21 can include a client-server application, where a client is located on each relay node and the server is remote and is a singleton. The clients frequently communicate with the server to pull mission updates (which can be represented in an XML format). The communication between the client and the server must be secure. In some embodiments, updates to the mission requirements can be transmitted to the relay through wireless or wired connections such as Ethernet cable.

The context awareness component 23 can gather information about the wireless network and the wireless network environment that surrounds the relay. The context-awareness component 23 can include a software-defined radio hardware component, a GPS device, a custom-built software application that dictates the radio to periodically scan the wireless medium and report back its findings, and a relational database that stores recent records of these findings. The information can include available spectrum bands, loading conditions, configuration of the nodes or relays, and node location. In some embodiments, the context-awareness component 23 gather the information by listening to the broadcast messages of the wireless network, or in some embodiments, the context-awareness component 23 gathers information by exchanging messages with the wireless network surrounding the relay. In some embodiments, the context-awareness component 23 can also gather information from other relays.

The knowledgebase component 25 is a means for organizing and retrieving information or knowledge stored by the relay. The knowledge base component 25 can correlate information, previous node decisions, and the outcomes of the decisions such that the relay can utilize the knowledge when making future decisions.

The decision-process component 27 receives information from the mission-awareness component 21, and the context-awareness component 23. In some embodiments, the decision-process component can also query the knowledgebase component 25. Using the information and data retrieved, the decision-process component 27 elects a course of execution which includes a specific use and management of the attributes and resources of the nodes in a way that is best suited to achieve the mission requirements. In some embodiments the decision-process component 27 can be realized, together with component 25, in the form a Bayesian Network, an Artificial Neural Network, or a Rule-based System. One example is that of Bayesian-based Decisions Support System (DSS) architecture. In the DSS architecture, the knowledge base component 25 is a relational database. The decision-process component 27 is a software-based implementation of a Bayesian model that captures the set of inputs to the decision-process (prior experiences from the knowledgebase combined with the context information received from the context-awareness component) and their probabilistic relationships and attempts to make a decision that maximizes the probability of meeting mission goals.

The execution phase components 22 executes the changes to the attributes and utilization of the available node resources 24, 26 in the existing network or other relays.

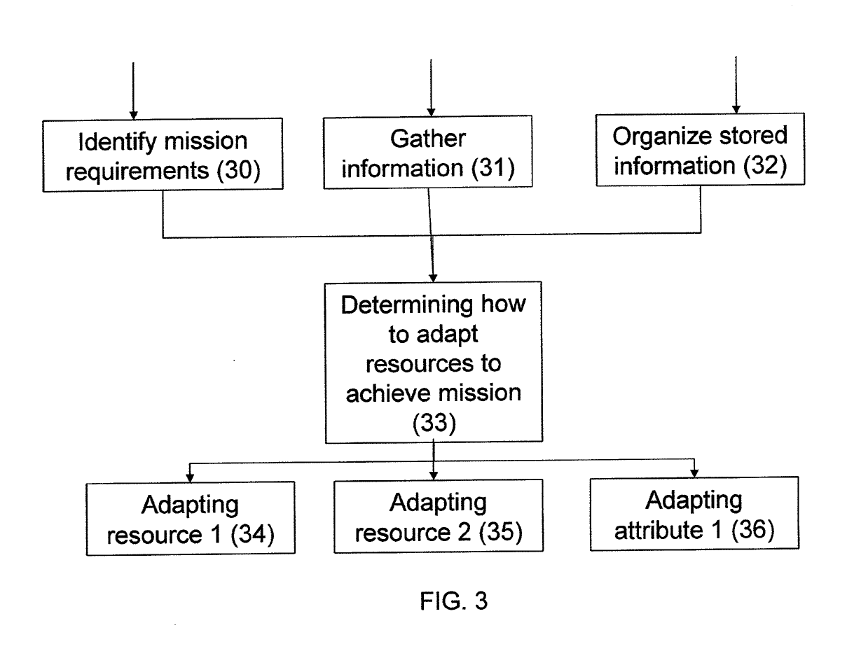

The relay can also be utilized as part of a method of optimizing a communications network. In one embodiment, FIG. 3, the method can include identifying mission requirements (30) based on data received from a mission station. The relay can also gather information (31) about an existing wireless communications network in communication with the relay. In some embodiments, the data is collected from other relays. The information can be gathered through communication with other relays and/or by monitoring the communication transmission of existing wireless networks. The method further includes organizing data collected from the existing wireless communication network and stored by the relay (32). Next, the relay determines how to adapt the resources to achieve the mission (33). This can include whether to form a new wireless network, configure the existing wireless communication network, or form a new wireless network and simultaneously or concurrently configure the existing wireless communication network to achieve the mission requirements. Based on the determining step, the relay attributes and relay resources are selected. In some embodiments, the relay attributes and relay resources can be adapted (34, 35, 36) based on the selecting step such that the relay achieves the mission requirements by doing at least one of creating the new wireless network, or configuring the existing wireless network by altering one or more resources of one or more network devices in the existing wireless communication network without altering a waveform characteristic and a network protocol stack of the existing wireless communication network.

Exemplary embodiments of the present invention can also be illustrated by the following use cases. In the first use case, the relay is introduced into a wireless cellular network, similar to the network design described in FIG. 1. In this use case, the relay can interface the existing base station (BS) of the wireless network. In some embodiments, the link between the BS and a relay can be constrained by the capability of the BS. Therefore, some of the functions for the relay are to decipher the management and data messages from the BS. The multiple access technique for this link needs to be interoperable with the BS's capability. For example, if the BS uses orthogonal frequency division multiple access (OFDMA) PHY/MAC layers and IP layer, the relay can support these protocols. Since the relay can act as a network manager, it can establish a secure SNMP session with the BS to optimize the BS's attributes such that the overall network performance can meet the mission goals. In some embodiments, if the BS is implemented using software defined radio (SDR), the BS can transform itself to match the capabilities of the relays as needed. The link between one or more relays can also adopt any of the multiple access techniques as outlined above in Table 1. In some embodiments, the relay also can interface the existing subscribers; with the possible constraint that the link between the relay and the subscriber can be constrained by the subscriber's capability. The multiple access technique for this link needs to be interoperable with the subscriber's capability. For example, if the subscriber uses orthogonal frequency division multiple access (OFDMA) PHY/MAC layers and IP layer, the relay can be required to support these protocols. However, if the subscriber is implemented using software defined radio (SDR), the subscriber can transform itself to match the capabilities of the relays if needed. Another option is to introduce new subscribers into the network where the new subscribers are a form of relays. This means that the relay has two modes of operation: one is relay and the other is subscriber. The relay can be implemented using SDR or the relay can have multiple chip sets. In this option, the multiple access technique between relay and subscriber can adopt any technique as outlined in Table 1.

The second use case is that there is no existing wireless network or the existing wireless network cannot meet the mission requirement even after reconfiguration of network's attributes. In this use case, the relay can communicate with each other to form an independent network. In some embodiments, the relay can also become a subscriber. The relay can adopt any multiple access technique or a hybrid of multiple access techniques (as outlined in Table 1) to form the new network. For example, part of the relay can use OFDMA in an urban area to accommodate non-line-of-sight environment and the remainder of the relay can deploy CDMA to simplify its operation. Another example is that when encountering harsh environments (urban canyons or heavy vegetation), the delay multiple access can be deployed to take advantage of multiple retransmissions to improve the message success rate between nodes. This can sometime result in delay but the relay will have determined that the mission requirement of throughput has a priority. Another example is that when the relays encounter heavy interference and are not able to be functional, the relays can instruct the subscribers and a subset of relays to go to sleep modes to reduce battery power consumption (if powered by battery) and reduce the chance of being discovered by other network. The remaining relays can then continue to sense the environment waiting for the interference to reduce. Once the interference level is subsidized, these relays can wake up the subscribers and/or the other relays. Another example is that the relay can be deployed on a platform with different speeds. The relay can sense its own mobility, which can result in the relay selectively electing its attributes and choosing the appropriate resources to accommodate the speed or movement. For instance, the slot size for TDMA or symbol duration for OFDMA can be increased for higher-speed operation. Another example is that time-critical messages must be passed from point A to point B. To ensure the high success rate of messages being received by point B, relays can form redundant paths from point A to point B.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A relay for a wireless communication network, the relay comprising:
a mission-awareness component configured to identify mission requirements based on information received from a mission station;
a context-awareness component configured to gather information about an existing wireless communications network in communication with the relay;
a knowledge-based component configured to organize and retrieve data collected from the existing wireless communication network and stored by the relay;
a decision process component configured to optimize the relay attributes and select the relay resources such that the relay achieves the mission requirements by doing at least one of (a) creating a new wireless communication network or (b) configuring the existing wireless communications network without altering waveform characteristics and network protocol stacks of the existing wireless communications network;
an execution component configured to optimize the relay attributes and select the relay resources in conformance with the selection made by the decision process component.

2. The relay of claim 1, where the relay attributes comprise location and mobility pattern.

3. The relay of claim 1, wherein the relay resources comprise time division, frequency or channel division, code division, hop division, delay division, space division, route division, transmit power division, power consumption division, and modulation and coding division.

4. The relay of claim 1, wherein the relay is configured to communicate with one or more relays.

5. The relay of claim 1 wherein the relay is configured to operate as a subscriber unit.

6. The relay of claim 4, where the relay resources can be configured in any combination to meet the mission requirements.

7. The relay of claim 1, wherein the relays can ensure interoperability of the existing wireless communication network and one or more additional wireless communication networks.

8. The relay of claim 1 wherein the mission requirements are dynamic.

9. The relay of claim 1 wherein the mission requirements can include choosing a different spectrum band, ensuring coexistence with other surrounding wireless networks that may cause interference, supporting mesh topology, supporting multicast, providing desired quality of service for user data, providing confidentiality, integrity, and reliability of data, providing low probability of jamming, interception and detection, supporting firewall for blocking malicious users, supporting secured storage under threat, supporting location service, supporting user mobility or some combination thereof.

10. The relay of claim 1 wherein the context-awareness component gathers information by recognizing the waveforms and protocol stacks of the existing wireless network, monitoring broadcast messages of the existing wireless communication network, exchanging messages with the existing wireless communication network, exchanging messages with one or more additional relays, or any combination thereof.

11. The relay of claim 1 wherein the context-awareness component gathers information that includes spectrum bands, loading conditions of the existing wireless communication network, the configuration of the existing wireless communication network, and the attributes of other relays.

12. The relay of claim 1 wherein the data process component receives data from the mission-awareness component, the context awareness component, the knowledge-based component, or some combination thereof.

13. The relay of claim 1 wherein the relay serves as a network manager when configuring the existing wireless communication network.

14. The relay of claim 1 wherein context awareness component is configured to scan the broadcast spectrum, identify the available bands, and identify the characteristics of each band.

15. A wireless communication network comprising:
one or more network devices with resources;
a relay that is adapted to interface with the one or more network devices and adapted to alter the resources of the one or more network devices without altering waveform characteristics and network protocol stacks of the wireless communication network, the relay comprising:
a mission-awareness component configured to identify mission requirements based on information received from a mission station;
a context-awareness component configured to gather information about an existing wireless communications network in communication with the relay;
a knowledge-based component configured to organize and retrieve data collected from the existing wireless communication network and stored by the relay;
a decision process component configured to select relay attributes and relay resources such that the relay achieves the mission requirements by doing at least one of (a) creating a new wireless network, or (b) configuring the existing wireless network without altering a carrier waveform characteristics and network protocol stack of the existing wireless communications network;
an execution component configured to adapt the relay attributes and relay resources in conformance with the selections made by the decision process component.

16. A method of utilizing a relay, the method comprising:
identifying mission requirements based on data received from a mission station;
gathering information about an existing wireless communications network in communication with the relay;
organizing data collected from the existing wireless communication network and stored by the relay;
determining whether to form a new wireless network, configure the existing wireless communication network, or form a new wireless network and configure the existing wireless communication network to achieve the mission requirements;
selecting relay attributes and relay resources based on the determining step;
adapting the relay attributes and relay resources based on the selecting step such that the relay achieves the mission requirements by doing at least one of (a) creating the new wireless network, or (b) configuring the existing wireless network by altering one or more resources of one or more network devices in the existing wireless communication network without altering a waveform characteristic and a network protocol stack of the existing wireless communication network.

17. The method of claim 16 further comprising utilizing a network management component to recognize the relay resources of the one or more network devices in the existing wireless communication network.

18. The method of claim 17 wherein the utilizing step further comprises recognizing the waveform characteristics of the existing wireless communication network.

19. The method of claim 16 wherein identifying mission requirements further comprises receiving data containing mission requirements through a wireless connection with the mission station.

20. The method of claim 16 wherein the gathering step further comprises scanning the broadcast spectrum, identifying the available bands, and identifying the characteristics of each band.
